(19) United States
(12) Patent Application Publication
(10) Pub. No.: US 2005/0121821 A1
(43) Pub. Date: Jun. 9, 2005

(54) Method and device for introducing a fiber into an injection head

(76) Inventor: Werner Horschlager, Pirka (AT)

Correspondence Address: YOUNG & THOMPSON, 745 SOUTH 23RD STREET, 2ND FLOOR, ARLINGTON, VA, 22202, US

(21) Appl. No.: 10/503,632

(22) PCT Filed: Jan. 30, 2003
(86) PCT No.: PCT/AT03/00029

(30) Foreign Application Priority Data
Feb. 6, 2002 (AT) A196/02

(51) Int. Cl. B29C 47/02

(52) U.S. Cl. 264/171.13; 425/114

(57) ABSTRACT

In order to feed a new fiber (1) or the like into an extrusion head (3) in as short a time as possible after the end of a first fiber (1′) which is already running through the extrusion head (3), a process and a device are proposed in which the new fiber (1) is made available immediately in front of or next to the extrusion head (3) in a feed device (10). As soon as the first fiber (1′) has reached its end, this feed device (10) is moved into the area in front of the extrusion head (3) and the new fiber (1) is accelerated and inserted into the extrusion head (3).

The invention relates to a process for guiding a new fiber or the like into an extrusion head for coating or cladding of the fiber, when a first fiber which is already in the extrusion head reaches the end, and a device for insertion or guidance of a new fiber or the like into an extrusion head for coating or cladding the fiber, with a feed means for the fibers into the extrusion head.

The invention relates to the feed and guidance of fibers or leads into an extrusion head, the invention being able to be used not only for individual fibers or leads, but also for one or more fibers with secondary coating, several loose fibers, fiber bundles, stranded fibers and several hanks of fiber bundles or stranded fibers or leads. Furthermore the fibers or leads can be produced from the most varied materials, for example, glass or plastic for optical fibers or copper for electrical lines. If hereinafter reference is made to fibers, all the aforementioned products are intended.

For coating or cladding of fibers they are guided through an extrusion head in which the coating or cladding is applied to the fibers. Since the fibers can be made available on rolls or. the like and can be routed into the extrusion head only in a finite length, at the end of a fiber it is necessary either to interrupt the process of cladding or coating in order to insert a new fiber into the extrusion head and then to restart the process, or to tolerate the fact that for an uninterrupted process of cladding and coating a relatively great length as scrap is formed until a second fiber is inserted again into the extrusion head after the end of the first fiber.

Therefore the object of the invention is to make available a process and a device by which the time is shortened for replenishing with a new fiber after the end of the preceding fiber.

This object is achieved with a process with the features of claim 1.

This object is furthermore achieved with a device with the features of claim 10.

The invention is based essentially on the fact that while a first fiber is running in the extrusion head, a new fiber is already being made available in a feed device which is positioned next to the first or the old fiber. Because the second fiber is being made available immediately in front of or next to the extrusion head, the change from the first to the second fiber can be carried out very quickly, by which in an uninterrupted process the material loss or scrap in the changing area from the first to the second fiber can be kept relatively low.

If in one preferred embodiment of the invention there are two, preferably identical feed means, specifically a first which is assigned to the fiber currently running through the extrusion head, and a second which is assigned to the fiber which has been made available, then, as soon as the end of the first fiber is reached, the first feed means is moved out of the area in front of the extrusion head, and the second feed means is at the same time positioned in front of the extrusion head, whereupon the second prepared fiber is immediately inserted into the extrusion head and accelerated until the intended processing or line speed of the fiber is reached again.

Ideally the first and the second feed means are moved at the same time. This takes place preferably by the two feed means being mounted on a frame which can be moved or swivelled in by the drive at a right angle or transversely to the insertion direction of the fiber into the extrusion head.

Basically a single fiber draw-off would be enough to withdraw the fiber from the fiber magazine and to deliver it into the extrusion head. It is preferable within the framework of the invention, when the new fiber is accelerated by a second fiber draw-off which is located into front of the extrusion head, that the delivery speed of a first fiber draw-off which is located in the direction of motion of the fiber in front of the second fiber draw-off is controlled depending on the length of the fiber which is present in a fiber magazine which is located between the first and the second fiber draw-off. In this way the acceleration of the fiber when a fiber is inserted or a new fiber is guided into the extrusion head can be carried out in an optimum manner, i.e. in a very short time.

Other preferred embodiments or implementations of the invention are the subject matter of the other dependent claims.

One preferred embodiment of the invention is described below with reference to the attached drawings.

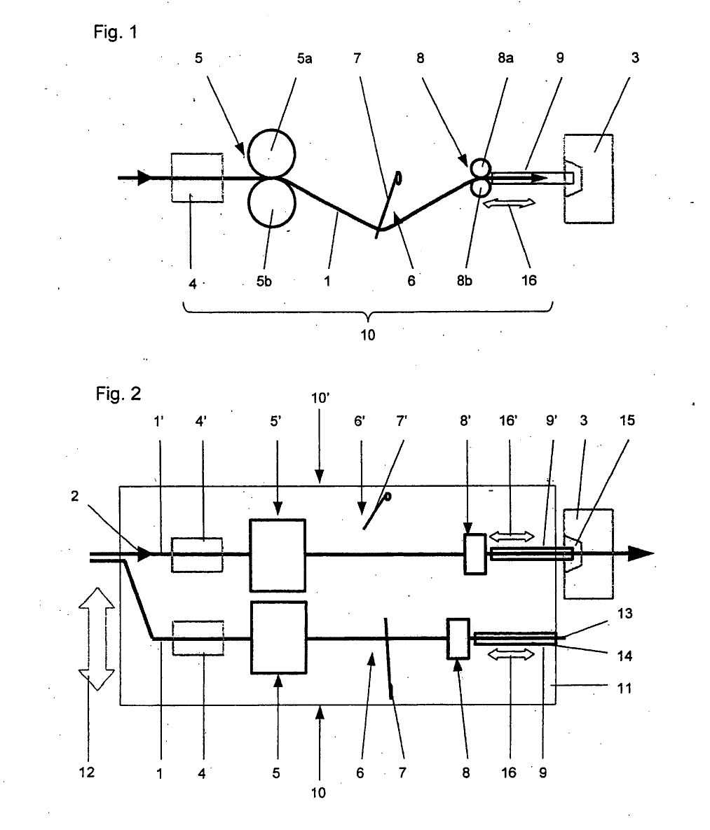

FIG. 1 shows a side view of a schematic of one embodiment of. the invention and

FIG. 2 shows an overhead view of the device as is shown in FIG. 1.

FIGS. 1 and 2 show representatively for all possible fibers, leads, or bundles of fibers or leads, as were mentioned initially, a single fiber 1 which is guided by a fiber magazine which is not shown in the drawings, for example a drum, arriving in the direction of the arrow 2, to an extrusion head 3 in which the fiber is coated or clad; this has been known for a long time in the prior art so that the extrusion head 3 is not detailed.

The fiber 1 arriving in the direction of motion 2 from the fiber magazine is guided through a prewetting unit 4, a first fiber draw-off 5, a fiber magazine 6 with a wire bow compensator 7, a second fiber draw-off 8 and a guide tube 9 into the extrusion head 3. The prewetting unit is not essential or can also be located elsewhere, for example between the first fiber draw-off 5 and the compensator 7 or the compensator 7 and the second fiber draw-off 8.

In normal operation, i.e. when this fiber 1 is guided with the normal operating or line speed through the extrusion head 3, the rolls 5a, 5b of the fiber draw-off 5 and the rolls 8a, 8b of the fiber draw-off 8 are opened and the wire bow componensator 7 is swivelled out of its contact or its action area with the fiber 1 so that the fiber 1 moves freely through the feed unit 10.

The fiber draw-offs 5 and 8 and the fiber magazine 6 are conventionally only closed or active when a new fiber 1 is being inserted or guided into the extrusion head in order to accelerate the fiber 1 up to the operating or line speed. But an operating mode is also possible in which the fiber draw-off 5 is always closed or active.

In order to be able to carry out insertion of a new fiber 1 into the extrusion head 3, or guidance of a new fiber 1 when a preceding fiber 1 ends into the extrusion head 3 in a time as short as possible, as is shown in FIG. 2, two essentially identically structured feed means 10, 10′ are mounted next to one another or on top of one another on a mounting plate or a mounting frame 11. The mounting frame 11 can be moved transversely to the direction of motion of the fiber 1, as is indicated by the double arrow 12, in order to be able to position the first feed means 10 on the one hand and then again to position the second feed means 10′ in front of the extrusion head 3.

In the embodiment shown in FIG. 2, a fiber 1′ is processed with normal operating speed, so that as mentioned the fiber draw-offs 5′ and 8′ and the fiber magazine 6′ are deactivated. The feed means 10 which is mounted next to the feed means 10′ on the mounting frame 11 is in the waiting position in the situation which is shown in FIG. 1 and in which a fiber 1 is prepared for feeding into the extrusion head 3, i.e., that the start 13 of the fiber 1 is positioned at the mouth 14 of the guide tube 9.

Immediately after the end of the fiber 1′ has entered the extrusion head 3 through the guide tube 9′, the guide tube 9′ is pulled back with the fiber draw-off 8′ and the mounting frame 11 is shifted (up in FIG. 2 in the plane of the figure) so that then the feed means 10 with the guide tube 9 is positioned in front of the extrusion head 3, whereupon the guide tube 9 is moved a short distance in the direction of motion of the fiber 1 forward and into the inlet area 15 of the extrusion head 3. The guide tubes 9, 9′ can also be made divided in the longitudinal direction. At essentially the same time the fiber draw-offs 5 and 8 begin to operate so that the new fiber 1 with its start 13 is inserted into the extrusion head 3. The synchronization of the fiber draw-offs 5 and 8 takes place such that first the fiber draw-off 8 stipulates the speed or acceleration of the fiber 1 and the fiber draw-off 5 using the wire bow compensator 7 is controlled in such a way that there is always enough fiber 1 in the fiber magazine 6.

With increasing length the coated or clad fiber is pulled at the same time more and more strongly by the draw-off which is located downstream of the extrusion head 3 (not shown in the drawings) over the cladding material, for example, a tube which jackets the fiber, whereupon the freewheel on the fiber draw-off 8 becomes active. The wire bow compensator 7 now causes the fiber draw-off 5 to be further accelerated.

When the fiber speed has reached a certain percentage (for example 90%) of the normal line or operating speed, the rolls 5a, 5b and 8a, 8b of the two draw-offs 5 and 8 are moved apart from one another and the wire bow compensator 7 is swivelled up out of its action area and is locked there. The guide tube 9 can also be pulled out of the extrusion head 3 in this stage and opened, so that the newly inserted fiber 1 is now running. completely freely.

In this state a new fiber can already be inserted into the now free feed means 10′.

If the motion of the guide tube 9, 9′ in the direction of motion of the fibers 1, 1′ into or out of the extrusion head 3 is to be carried out in the direction of the double arrow 16, 16′ (under certain circumstances it can also be abandoned) it is possible to move not only the guide tube 9, 9′ optionally together with the fiber draw-off 8, 8′, relative to the mounting frame 11, but it is also possible to mount the guide tube 9, 9′ stationary on the mounting frame 11 and to carry out not only motion in the direction of the arrow 12 from the mounting frame 11, but also in the direction of fiber motion, therefore of the arrows 16, 16′.

For suitable control and acceleration of the feed of the fibers 1, 1′ to the feed means 10, 10′ it is also possible to abandon the fiber draw-off 5 with the fiber magazine 6, and to use only the fiber draw-off 8, 8′.

But basically it is also conceivable to mount the first feed means 10′ and the second feed means 10, not on a common mounting plate 11, but to provide two mounting plates, each mounting plate being equipped with its own drive and being movable independently of the other mounting plate. According to one embodiment of the invention which is not shown in the drawings, there is only a single feed means 10′ which in turn can consist of a first fiber draw-off 5, a fiber magazine 6′, a second fiber draw-off 8′ and a guide tube 9′. A wetting unit 4′ would have to be located elsewhere, if it is necessary at all.

Since, as mentioned, the feed means during current operation can be deactivated anyway, it can be moved away from the current fiber laterally or up or down so that it can then assume the position which is assumed in FIG. 2 by the feed means 10. In the area of the current or first fiber 1′ then there would be no feed means. In the feed means 10′ which is located next to the fibers 1′, then in turn a new or second fiber 1 can be prepared and inserted and the feed means 10′, when the first fiber 1′ is approaching the end, would be moved again into the feed area in front of the extrusion head 3, whereupon the prepared fiber 1 can be inserted into the extrusion head. After completed insertion or acceleration of the new fiber to the operating speed, the feed means 10′ can then be moved away again out of the area of the fiber 1′. In this way operation as claimed in the invention for the device as claimed in the invention is also possible when there is only a single feed means 10′.

The invention can of course be used not only for guiding a fiber, when in current operation a fiber is coming to an end, but also for first-time insertion of a fiber at the start of operation.

In summary, one preferred embodiment of the invention can be described as follows:

In order to feed a new fiber 1 or the like into an extrusion head 3 in a time as short as possible after the end of a first fiber 1′ which is already running through the extrusion head 3, a process and a device are proposed in which the new fiber 1 is already made available immediately in front of or next to the extrusion head 3 in a feed means 10. As soon as the first fibber 1′ has reached the end, this feed means 10 is moved into the area in front of the extrusion head 3 and the new fiber 1 is accelerated and inserted into the extrusion head 3.

1. Process for guiding a new fiber (1) or the like into an extrusion head (3) for coating or cladding of the fiber (1), when a first fiber (1′) which is already in the extrusion head (3) is reaching the end, characterized in that the new fiber (1) is made available in a feed means (10) which is located next to the first fiber, that the feed means (10) after the end of the first fiber (1′) is positioned in front of the extrusion head (3), and that the new fiber (1) is inserted into the extrusion head (3) and accelerated.

2. Process as claimed in claim 1, wherein the first fiber (1′) is guided by a first feed means (10′) into the extrusion head (3), and wherein the first feed means (10′) after the end of the first fiber (1′) is moved away from the extrusion head (3) before or while the second feed means (10) for the new fiber (1) is positioned in front of the extrusion head (3).

3. Process as claimed in claim 1, wherein the motion of the feed means (10, 10′) takes place roughly at a right angle to the direction of motion of the fiber (1, 1′).

4. Process as claimed in claim 2, wherein the first and the second feed means (10, 10′) are moved at the same time.

5. Process as claimed in claim 1, wherein the new fiber (1) is accelerated by a second fiber draw-off (8) which is located into front of the extrusion head (3) and wherein the delivery speed of a first fiber draw-off (5) which is located in the direction of motion of the fiber (1) in front of the second fiber draw-off (8) is controlled depending on the length of the fiber (1) which is present in a fiber magazine (6) which is located between the first (5) and the second (8) fiber draw-off.

6. Process as claimed in claim 5, wherein the second fiber draw-off (8) is deactivated after reaching a first given speed of the fiber (1).

7. Process as claimed in claim 6, wherein the first fiber draw-off (5) is deactivated after reaching a second given speed of the fiber (1).

8. Process as claimed in claim 5, wherein the first and the second fiber draw-off (5, 8) are deactivated at the same time after reaching a given speed of the fiber (1).

9. Process as claimed in claim 7, wherein the fiber magazine (6) is deactivated at the same time with deactivation of the first fiber draw-off (5).

10. Device for insertion or guidance of a new fiber (1) or the like into an extrusion head (3) for coating or cladding the fiber (1), with a feed means (10, 10′) for the fiber (1) into the extrusion head (3), wherein the feed means (10′) can be positioned next to the first fiber (1) which is already running into the extrusion head (3) and-wherein there is a drive with which the feed means (10, 10′) can be positioned in front of the extrusion head (3).

11. Device as claimed in claim 10, wherein there are a first feed means (10) for the first fiber and a second feed means (10′) for the new fiber (1), and wherein the second feed means (10′) is located next to the first feed means (10).

12. Device as claimed in claim 11, wherein each feed means (10, 10′) has its own drive.

13. Device as claimed in claim 11, wherein the two feed means (10, 10′) have a common drive.

14. Device as claimed in claim 12, wherein the two feed means (10, 10′) are mounted on a frame (11) which can be moved by the drive at a right angle to the insertion direction of the fiber (1, 1′) into the extrusion head (3).

15. Device as claimed in claim 10, wherein the feed means (10, 10′) has (have) a first (5, 5′) and a second (8, 8′) fiber draw-off and a fiber magazine (6, 6′) which is located in between.

16. Device as claimed in claim 10, wherein the feed means (10, 10′) has (have) on the outlet side a guide tube (9, 9′) which can be positioned in front of the inlet (15) of the extrusion head (3).

17. Device as claimed in claim 16, wherein the guide tube (9, 9′) can be moved in the insertion direction of the fiber (1, 1′) in the extrusion head (3).
